(19) United States
(12) Patent Application Publication
(10) Pub. No.: US 2023/0268856 A1
(43) Pub. Date: Aug. 24, 2023

(54) INVERTER GENERATOR - SYNCHRONOUS ALTERNATOR HYBRID

(71) Applicant: Steven Mark Jones, Mason, NH (US)

(72) Inventor: Steven Mark Jones, Mason, NH (US)

(21) Appl. No.: 17/803,124

(22) Filed: Feb. 22, 2022

(51) Int. Cl. H02P 9/02; F02B 63/04; F02D 29/06

(52) U.S. Cl. CPC H02P 9/02; F02B 63/042; F02D 29/06; F02D 2200/101

(57) ABSTRACT

The invention was conceived to facilitate in the advancement in internal combustion engine driven generators. Generators today consist of either an inverter generator design or a synchronous alternator design. Both designs have their advantages and disadvantages. The inverter generator offers very precise AC power output, lower noise level, and lower fuel consumption rates but can’t handle heavy inductive loads well. The synchronous alternator offers slightly less precise AC power output, greater noise level, higher fuel consumption rates but can power heavy inductive loads very well.

The invention incorporates both, known inverter generator design and known synchronous alternator design, connected to an internal combustion engine, to form a hybrid generator design. The hybrid dual generator/alternator design makes it possible for the invention to capitalize on all the advantages of both inverter generator and synchronous alternator designs, while eliminating all the disadvantages of both inverter generator and synchronous alternator designs.

### CROSS-REFERENCE TO RELATED APPLICATIONS

This application is related to and claims priory from Provisional Patent Application Ser. No. 63/207,364 filed Feb. 23, 2021

### STATEMENT REGARDING FEDERALLY SPONSORED RESEARCH OR DEVELOPMENT

“Not Applicable”

### INCORPORATION - BY - REFERENCE OF MATERIAL SUBMITTED ON A COMPACT DISC.

“Not Applicable”

### BACKGROUND OF THE INVENTION

Internal combustion engine driven, alternating current generators sold today are many designed in two different forms, an inverter generator and a synchronous alternator.

Today’s conventional inverter generators produces clean AC power output with enhanced fuel efficiency compared to today’s conventional synchronous alternator, due to the capability for the internal combustion engine to operate at a variable speed and lower speed.

The advantage of the inverter generator design over the synchronous alternator design, enables the user to have an internal combustion engine driven generator with lower noise levels and better fuel economy, compared to conventional synchronous alternator designs.

Today’s conventional synchronous alternators produce marginally less precise AC power output and reduced efficiency compared to today’s conventional inverter generators design, due to the required fixed high speed at all times.

The advantage of the synchronous alternator design over the inverter generator design is the increased durability, in a constant heavy inductive load or an extended run period, under a heavy load environment. This harsh environment would decrease the operational life of the inverter generator.

### BRIEF SUMMARY OF THE INVENTION

The invention is powered by an internal combustion engine and drives both a known inverter generator and a known synchronous alternator. This single internal combustion engine with the dual generator/alternator hybrid design enables the user to have greater electrical output flexibility and improved fuel efficiency compared to conventional generators today. Whereas a single combustion engine drives either an inverter generator or a single combustion engine drives a synchronous generator.

The invention enables an internal combustion engine driven generator, to offer the benefits of both, known inverter generator and known synchronous alternator design incorporated into one internal combustion engine driven generator/alternator design, instead of two different combustion engine generators and alternators.

When a low electrical demand is encountered, the invention switches over to a very fuel efficient inverter generator design, with grid like electrical power similar to conventional inverter generators.

When a high electrical demand is encountered, the invention switches over to a very durable and effective synchronous alternator design, that can handle heavy inductive or constant, extended period heavy load demand, similar to conventional synchronous alternators.

The invention enables an inverter generator and a synchronous alternator to work together as one generator, exploiting all the best characteristics of each design. This is due to the capability to select operational modes in both the inverter generator and the synchronous alternator, either by manual or automatic means.

The invention also, eliminates the all worst characteristics of the conventional inverter generator and the conventional synchronous alternator designs and has the capability to operate either the inverter generator or the synchronous alternator independently or combined with its CPU controlled systems.

The invention is capable of adapting to a broader spectrum of electrical needs for the user, by means of maximizing both conventional inverter generators and conventional synchronous alternators designs to their fullest potential. Therefore, the invention is an improvement in internal combustion driven generators and its capabilities exceeds all existing conventional inverter generators and conventional synchronous alternators today.

The invention exhibits a combination of known elements that are shown to be nonobvious, i.e.: known inverter generator and known synchronous alternator but are connected into one electrical generator unit, driven by an internal combustion engine, which has not been done before.

### BRIEF DESCRIPTION OF THE SEVERAL VIEWS OF THE DRAWINGS

FIG. 1: Side view of invention with numbered components

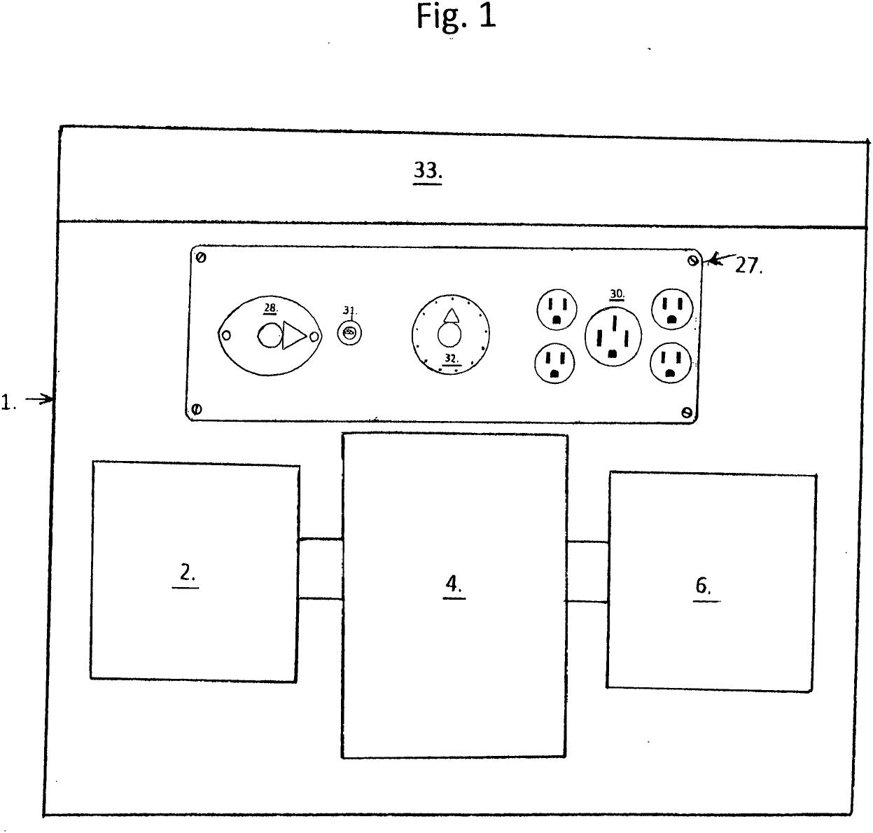

FIG. 2: Side view of invention with numbered components

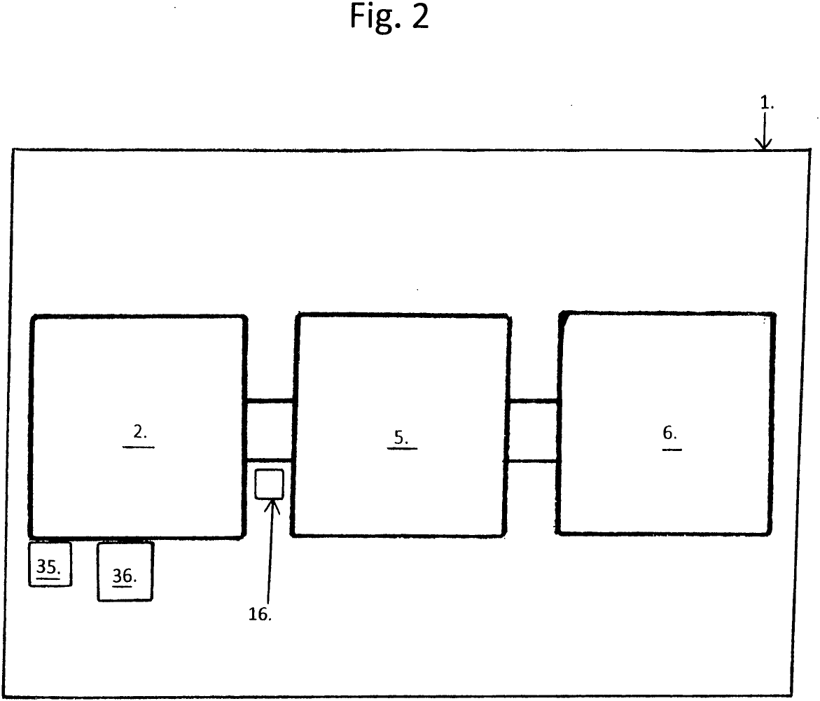

FIG. 3: Side view of invention with numbered components

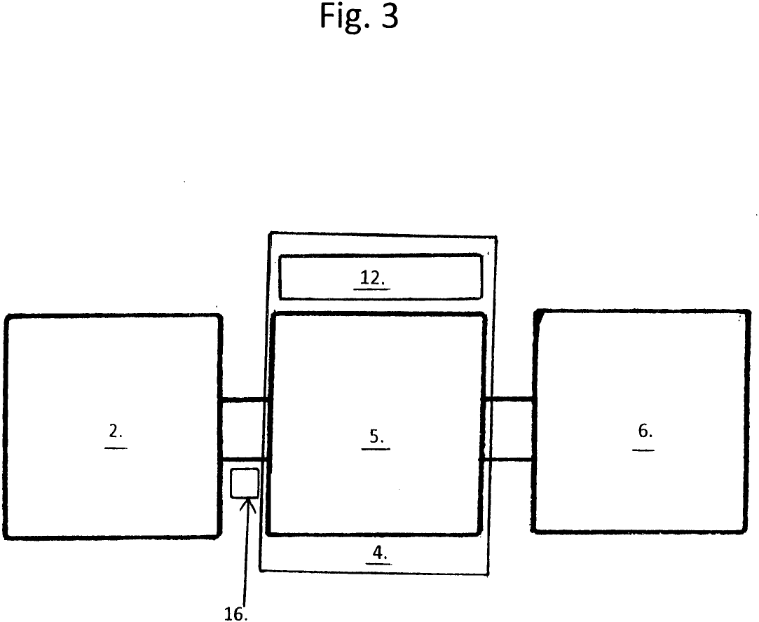

FIG. 4: View of I-G component cabinet with numbered components

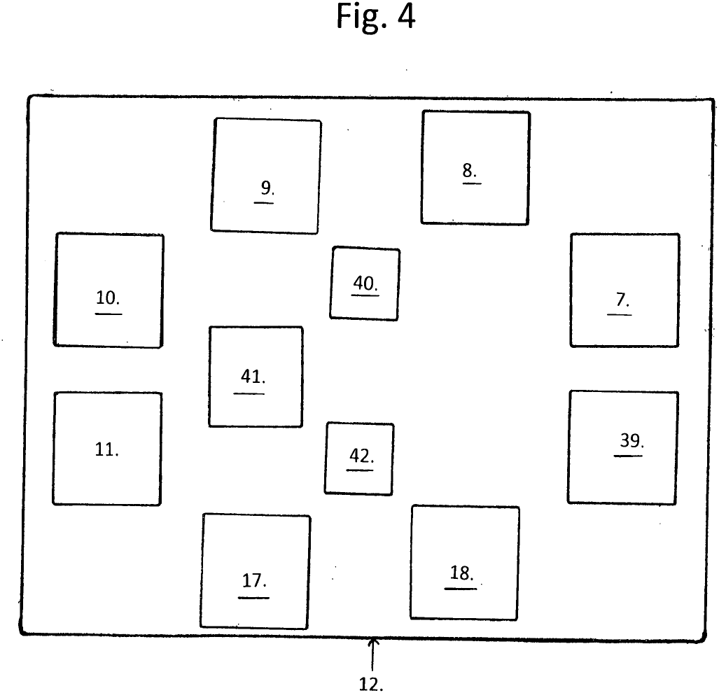

FIG. 5: View of electronic component cabinet with numbered components

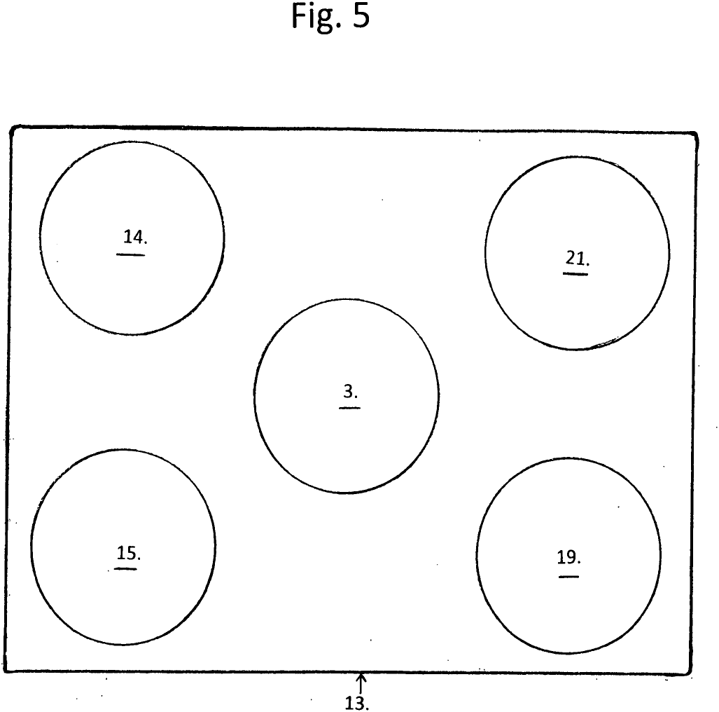

FIG. 6: View of invention with numbered components

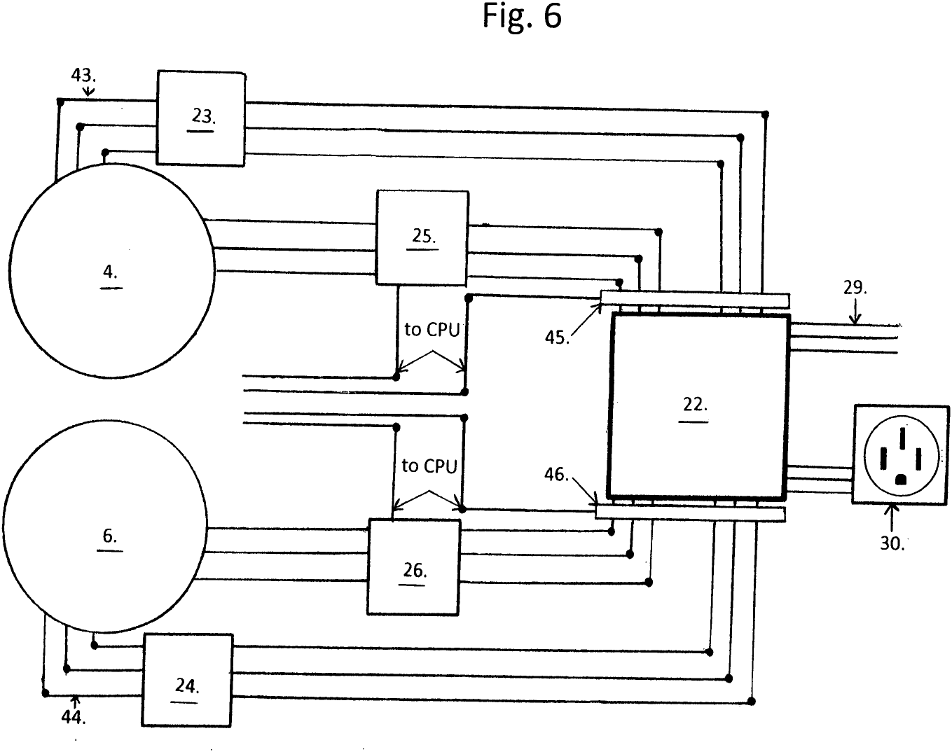

FIG. 7: View of inverter generator with numbered components

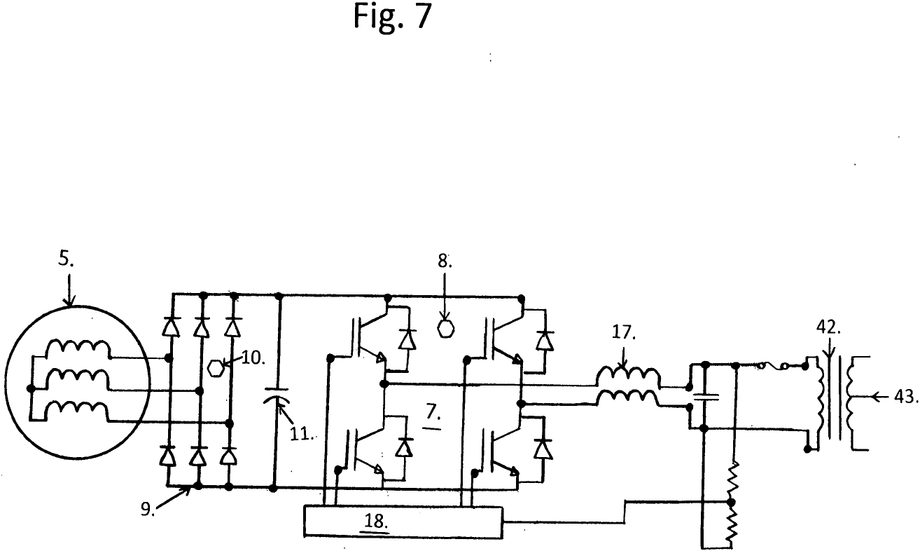

FIG. 8: View of synchronous alternator with numbered components

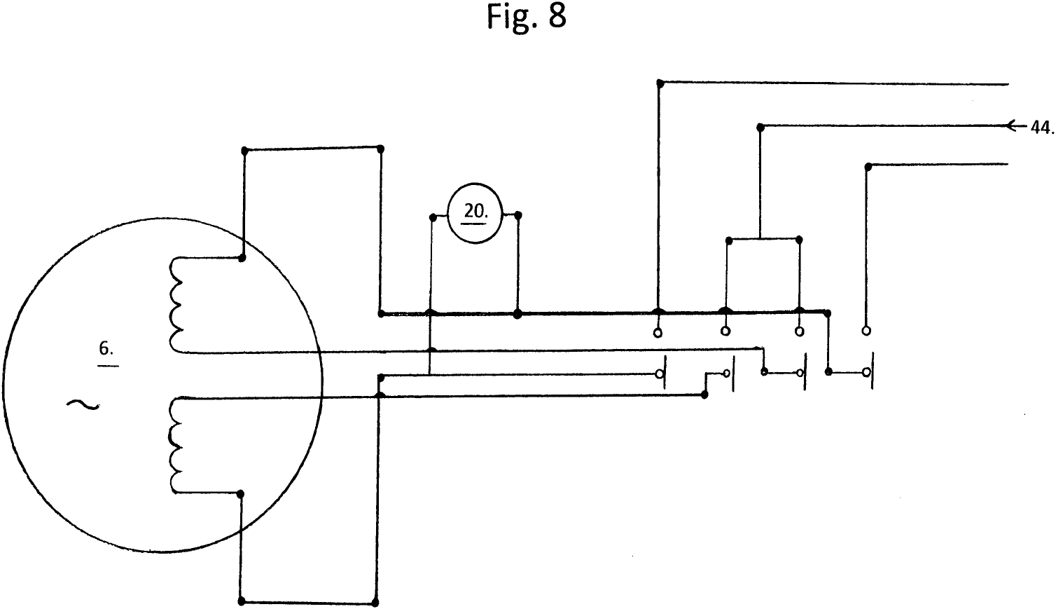

FIG. 9: Side view of invention with numbered components

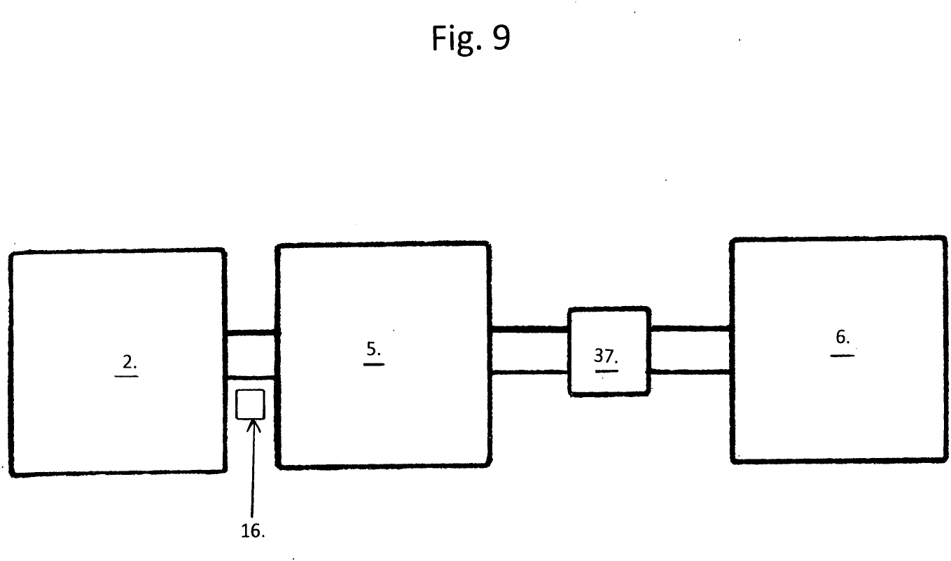

FIG. 10: Side view of invention with numbered components

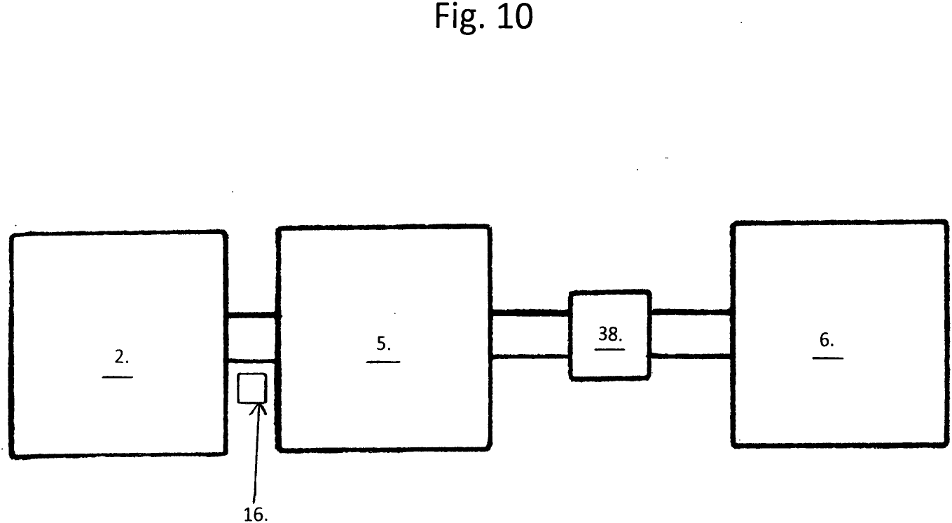

FIG. 11: View of invention of panel with numbered components

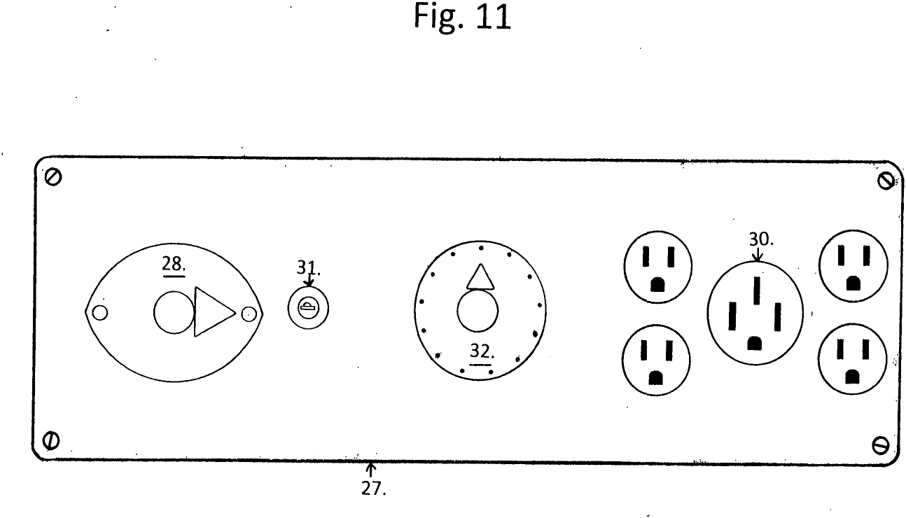

FIG. 12: View of invention of with numbered components

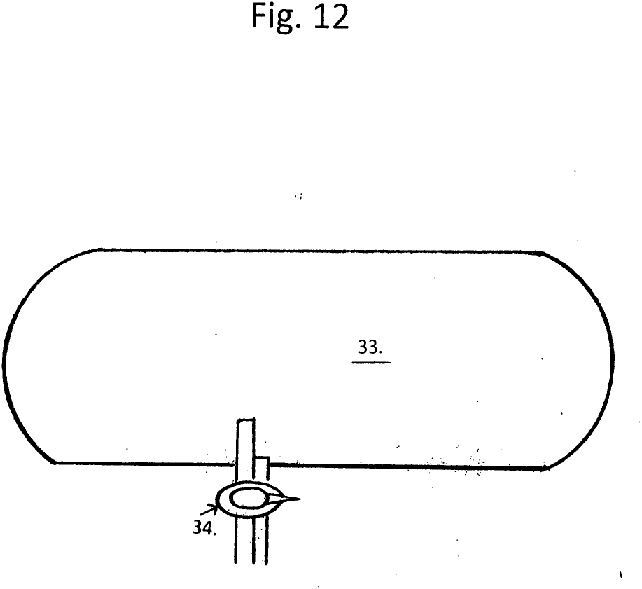

### REFERENCE CHARACTERS

### Components

1. Frame
2. Internal combustion engine
3. Engine ECU
4. Inverter generator
5. Inverter generator high frequency permanent magnet alternator
6. Synchronous 50 cycle or 60 cycle alternator
7. DC to AC inverter
8. DC to AC inverter temperature sensor
9. Rectifying system
10. Rectifier temperature sensor
11. Capacitors
12. Inverter generator component cabinet
13. Electronic component cabinet
14. CPU
15. Current sensing unit
16. Engine speed sensing unit
17. Inverter generator current line filter
18. Inverter generator pulse width modulation (PWM)control
19. Electronic engine speed control
20. Synchronous alternator voltage regulation unit
21. Synchronous alternator frequency regulation unit
22. Synchronizing unit for the inverter generator and synchronous alternator
23. Manual medium output breaker for inverter generator
24. Manual high output breaker for synchronous alternator
25.CPU activated transfer switch medium output breaker for inverter generator
26.CPU activated transfer switch high output breaker for synchronous alternator
27. Generator control panel
28. Manual or automatic transfer switch to change between the inverter generator and the synchronous alternator
29. Electrical outputs
30. Electrical outlets
31.On - off starting switch selector
32. CPU selector/s for modes
33. Fuel tank
34. Fuel petcock
35. Starting battery/capacitor power charging system
36. Starting battery/capacitor power system
37. Electric clutch
38. Manual/centrifugal clutch
39. Inverter generator storage power system
40. Inverter generator storage power system voltage sensor
41. Inverter generator storage power system charging system
42. Transformer
43. Inverter generator electrical outputs
44. Synchronous alternator electrical outputs
45. Inverter generator current sensor
46. Synchronous alternator current sensor

### DETAILED DESCRIPTION OF THE INVENTION

The invention has a Frame (1) an Internal combustion engine (2), coupled to the engine (2) are the Inverter generator high frequency permanent magnet alternator (5) and the Synchronous alternator (6). Within the Inverter generator (4) comprises: Inverter generator component cabinet (12), Inverter generator high frequency permanent magnet alternator (5), DC to AC inverter (7), DC to AC inverter temperature sensor (8), Rectifying system (9), Rectifier temperature sensor (10), Capacitors (11), Inverter generator current line filter (17) Inverter generator pulse width modulation (PWM) control (18) Inverter generator storage power system (39), Inverter generator storage power system voltage sensor (40), Inverter generator storage power system charging system (41) a Transformer (42).

There is an Electronic component cabinet (13) that contain the following components: CPU (14), Current sensing unit (15), Engine ECU (3), Electronic engine speed control (19) and Synchronous alternator frequency regulation unit (21). The Synchronous alternator (6) with the Synchronous alternator voltage regulation unit (20) can be configured to but not limited to: a 2 pole, 4 pole or 6 pole, 50 cycle or 60 cycle alternator design. A Synchronizing unit for the inverter generator and synchronous alternator (22) enables both the inverter generator (4) and synchronous alternator (6) electrical outputs (43) and (44) to be safely and properly combined.

There is a Manual medium output breaker for the inverter generator (23) and the Manual high output breaker for the synchronous alternator (24), CPU activated transfer switch for medium output breaker for inverter generator (25) and the CPU activated transfer switch for high output breaker for the synchronous alternator (26).

There is a Generator control panel (27) that can has an On-off starting switch selector (31), CPU selector/s for modes (32) and/or Manual or automatic transfer switch to change between the inverter generator and the synchronous alternator (28), Electrical outputs (29), Electrical outlets (30), and there is an optional fuel tank (33).

### METHOD OF OPERATION

To operate, turn the fuel petcock (34) to the on position, set the On-off starting switch selector (31) to the run position, set heating grid, glow plugs or choke, etc. now manually or electrically start the Engine (2). The Engine (2) can have any fuel source. Once operating, set choke (if a carbureted gasoline engine) to run position. When the engine (2) is warmed up, the required electrical load/s can be plugged into the generators electrical outlets (30) if it was a portable model.

If the invention was a permanently mounted generator model the electrical outputs (29) from the generator would be hard wired and the electrical plug outlets (30) would be eliminated and connected to but not limited to i.e.: manual or automatic transfer switch to house, building, etc..

The Inverter generator high frequency alternator (5) generates but not limited to: 3 phase alternating current (AC), which its output lead connects to the Rectifying system (9) the produced 3 phase AC is converted to direct current (DC) by means of the Rectifying system (9).

Capacitors (11) are added to the circuit to smooth the rectified DC waveform from the Rectifying system (9) to the DC to AC inverter (7), an Inverter generator current line filter (17) help clean up the AC line current and the Inverter generator pulse width modulation (PWM) control (18) creates the control pulses of the inverter switches.

Therefore, the frequency and amplitude of the output voltage are controlled by the reference signal used for the modulation and controls the inverter output frequency regulation and output voltage and to reduce the harmonic content in the output voltage. There is an Inverter generator storage power system (39) by means of a battery or capacitor to provide supplemental stored electrical power connected to the DC to AC inverter (7).

Electrical power output is monitored by the CPU (14) by means of the Current sensing unit (15), Inverter generator current sensor (45) and Synchronous alternator current sensor (46) and increases or decreases engine output power or vary the engine speed by means of Engine speed sensing unit (16) and Electronic engine speed control (19) in accordance with the load current by means of the Current sensing unit (15), Inverter generator current sensor (45) and Synchronous alternator current sensor (46). The CPU (14) can have a factory programed automatic mode load current settings or programmable manual load current settings by means of the CPU selector/s for modes (32).

The Inverter generator (4) electrical outputs (43) can be connected to an optional Transformer (42) to provide proper voltage to either a Manual medium output breaker (23) or the CPU activated transfer switch for medium output breaker (25). The Current sensing unit (15), Inverter generator current sensor (45) and Synchronous alternator current sensor (46) enables the CPU (14) to shift the power output from the medium power output to the high power output when required, by means of Current sensing unit (15), Inverter generator current sensor (45) and Synchronous alternator current sensor (46) load sensing or a manual selector mode, manual load current settings by means of the CPU selector/s for modes (32) in the CPU (14) that enables a set medium output power setting and the high output power setting.

If the manual medium output power load current settings by means of the CPU selector/s for modes (32) and/or Manual or automatic transfer switch to change between the inverter generator and the synchronous alternator (28) is selected, the Engine (2) will operate at but not limited to: a variable speed and the power output is monitored by the CPU (14) by means of the Rectifier temperature sensor (10), DC to AC inverter temperature sensor (8), Current sensing unit (15) Inverter generator current sensor (45), Synchronous alternator current sensor (46) and varies the engine speed by means of Engine speed sensing unit (16), Electronic engine speed control (19) and Engine ECU (3), in accordance with the load current by means of the Current sensing unit (15), Inverter generator current sensor (45) and Synchronous alternator current sensor (46) and the Inverter generator (4) electrical power will pass through the Manual medium output breaker (23) to provide a safe breaker system properly calibrated for the medium output setting.

If the automatic medium output power load current settings by means of the CPU selector/s for modes (32) is selected, the engine will operate at but not limited to: a variable speed and the CPU (14) will engage the CPU activated transfer switch for medium output breaker (25) and the Inverter generator (4) electrical power will pass through the CPU activated transfer switch for medium output breaker (25) to provide a safe breaker system properly calibrated for the medium output setting.

When the medium automatic mode setting is selected by means of the CPU selector/s for modes (32) the CPU (14) can vary the engine speed to configure the proper set rpm maintain adequate input power from the Engine (2) to drive the Inverter generator high frequency alternator (5) by means of the Rectifier temperature sensor (10), DC to AC inverter temperature sensor (8), Engine speed sensing unit (16), Electronic engine speed control (19) and Engine ECU (3), Inverter generator current sensor (45) and Synchronous alternator current sensor (46) in accordance with the load current by means of the Current sensing unit (15), Inverter generator current sensor (45) and Synchronous alternator current sensor (46).

If the manual high output power load current settings by means of the CPU selector/s for modes (32) and/or Manual or automatic transfer switch to change between the inverter generator and the synchronous alternator (28) is selected, the Engine (2) will operate at a set speed and the power output is monitored by the CPU (14) by means of the Current sensing unit (15), Inverter generator current sensor (45) and Synchronous alternator current sensor (46) and the set engine speed will be maintained by means of the Engine speed sensing unit (16), Electronic engine speed control (19) and Engine ECU (3) in accordance with the load current by means of the Current sensing unit (15) and the Synchronous alternator (6) electrical power will pass through by means of the Manual high output breaker for synchronous alternator (24) to provide a safe breaker system properly calibrated for the high output setting.

If the automatic high output power load current settings by means of the CPU selector/s for modes (32) and/or Manual or automatic transfer switch to change between the inverter generator and the synchronous alternator (28) is selected, the Engine (2) will operate at a set speed and the power output is monitored by the CPU (14) by means of the Current sensing unit (15), Inverter generator current sensor (45) and Synchronous alternator current sensor (46) and the set engine speed will be maintained by means of the Engine speed sensing unit (16), Electronic engine speed control (19) and Engine ECU (3) in accordance with the load current by means of the Current sensing unit (15) and the Synchronous alternator (6) electrical power will pass through by means of the CPU activated transfer switch for high output breaker (26) to provide a safe breaker system properly calibrated for the high output setting

The Synchronous alternator (6) produces either but not limited to: single or 3 phase electrical output. The engine speed is set at a fixed rpm in accordance to but not limited to: a 2 pole, 4 pole or 6 pole alternator design to produce the required 50 cycles or 60 cycles, by means of the CPU (14), which monitors the required engine speed by means of Engine speed sensing unit (16) and Electronic engine speed control (19), Engine ECU (3) and the Synchronous alternator frequency regulation unit (21), to maintain optimum frequency regulation.

The Synchronous alternator (6) voltage output is monitored and controlled by means of the Synchronous alternator voltage regulation unit (20). The Synchronous alternator (6) output is connected to either the Manual high output breaker for synchronous alternator (24) or the CPU activated transfer switch for high output breaker for synchronous alternator (26).

If the manual high output power load current setting by means of the CPU selector/s for modes (32) and/or Manual or automatic transfer switch to change between the inverter generator and the synchronous alternator (28) is selected, the Engine (2) would operate at a set speed and not fluctuate engine rpm speed and not shift back to the Inverter generator (4) medium output mode when the load is reduced. This is the heavy duty power mode setting, for heavy loads to be powered on and off with the engine maintaining maximum power output the entire duration and the manual high output breaker for synchronous alternator (24) stays engaged to provide a safe breaker system properly calibrated for the high output setting.

If the automatic high output power load current setting by means of the CPU selector/s for modes (32) and/or Manual or automatic transfer switch to change from inverter generator to the synchronous alternator (28) is selected, the CPU (14) will monitor the electrical load demand by means of the Current sensing unit (15), Inverter generator current sensor (45), Synchronous alternator current sensor (46), Engine speed sensing unit (16), Electronic engine speed control (19) and Engine ECU (3) in accordance with the load current by means of the Current sensing unit (15), Inverter generator current sensor (45) and Synchronous alternator current sensor (46) and the CPU activated transfer switch for high output breaker for synchronous alternator (26) stays engaged at all times to provide a safe breaker system properly calibrated for the high output setting.

The automatic mode would operate at high power level until the load is reduced. The CPU (14) will monitor the reduced electrical load by means of the Current sensing unit (15), Inverter generator current sensor (45) and Synchronous alternator current sensor (46). Then after a predetermined manual or automatic time interval for the reduced electrical load, set within the CPU (14). The CPU (14) would then engage the CPU activated transfer switch for medium output breaker for inverter generator (25) to match the line current requirement by means of the Current sensing unit (15), Inverter generator current sensor (45) and Synchronous alternator current sensor (46).

The Inverter generator (4) will now be engaged to power the lower electrical power requirements and the and the Synchronous alternator (6) will be disengaged by means the CPU (14) and the CPU activated transfer switch for high output breaker for synchronous alternator (26) and left on standby and monitored by the CPU (14) and the Current sensing unit (15), Inverter generator current sensor (45) and Synchronous alternator current sensor (46) until the next time a high power electrical load requirement is encountered.

The CPU (14) also monitors the Inverter generator (4) components by means of the Rectifier temperature sensor (10) and the DC to AC inverter temperature sensor (8). This enables the CPU (14) to closely monitor not only the electrical load by means of the Current sensing unit (15), Inverter generator current sensor (45) and Synchronous alternator current sensor (46) but also the temperature of the Rectifying system (9) and the Inverter generator (4).

When the CPU selector/s for modes (32) and/or Manual or automatic transfer switch to change between the inverter generator and the synchronous alternator (28) was in the manual medium output mode and the CPU (14) receives a signal from either the Rectifier temperature sensor (10) and/or the DC to AC inverter temperature sensor (8) that there is an overheating situation, the CPU (14) can perform an automatic shutdown of the Inverter generator (4) to protect the equipment and the output power will stop.

The Inverter generator (4) will not be able to produce output power by means of the Rectifier temperature sensor (10) and the DC to AC inverter temperature sensor (8) until the Rectifying system (9) and the Inverter generator (4) are cooled to a safe temperature. The Engine (2) can but not limited to: continue to run offering cooling air flow through the Inverter generator (4) components to bring down the produced high temperature of the Rectifying system (9) and the Inverter generator (4).

When the CPU selector/s for modes (32) and/or Manual or automatic transfer switch to change between the inverter generator and the synchronous alternator (28) was in the automatic medium output mode and the CPU (14) receives a signal from either the Rectifier temperature sensor (10) and/or the DC to AC inverter temperature sensor (8) that there is an overheating situation, the CPU (14) can automatically shift the output current from the Inverter generator (4) by means of the CPU activated transfer switch medium output breaker for the inverter generator (25).

Then the CPU (14) will increase engine speed to set proper frequency regulation by means of the engine ECU (3), Engine speed sensing unit (16), Electronic engine speed control (19) and then activate the Synchronous alternator (6) by means of the CPU activated transfer switch high output breaker for the synchronous alternator (26) and disengage the Inverter generator (4) by means of the CPU activated transfer switch medium output breaker for the inverter generator (25).

Now the Synchronous alternator (6) carries the electrical load which allows the Rectifying system (9) and the Inverter generator (4) to cool down to protect the components. The CPU (14) will monitor the temperature of the Rectifying system (9) and the Inverter generator (4) by means of the Rectifier temperature sensor (10) and the DC to AC inverter temperature sensor (8) and the CPU (14) will monitor line current load by means of the Current sensing unit (15), Inverter generator current sensor (45) and Synchronous alternator current sensor (46) and the CPU (14) will continue operation of the Synchronous alternator (6) by means of the CPU activated transfer switch high output breaker for the inverter generator (26) until the high required electrical load is reduced.

The automatic medium mode with the Inverter generator (4) will not be able to be engaged and produce output power until the Rectifying system (9) and the Inverter generator (4) are cooled to a safe temperature and monitored by means of the CPU (14), Rectifier temperature sensor (10) and the DC to AC inverter temperature sensor (8).

When the CPU (14) and the Current sensing unit (15), Inverter generator current sensor (45) and Synchronous alternator current sensor (46) monitor the high load subside to a lower electrical load and the Rectifying system (9) and the Inverter generator (4) are cooled down to an acceptable level by means of the Rectifier temperature sensor (10) and the DC to AC inverter temperature sensor (8).

The CPU (14) can disengage the Synchronous alternator (6) by means of the CPU activated transfer switch high output breaker for the inverter generator (26) and engage the Inverter generator (4) and the CPU activated transfer switch for medium output breaker (25) to match the line current requirement by means of the Current sensing unit (15), Inverter generator current sensor (45) and Synchronous alternator current sensor (46).

The configuration of the Inverter generator high frequency permanent magnet alternator (5) and the Synchronous 50 cycle or 60 cycle alternator (6) can be mechanically connected to the engine (2) or the engine (2) can be mechanically connected to the Inverter generator high frequency permanent magnet alternator (5) and an optional Electric clutch (37) or a Manual or centrifugal clutch (38) can be added between the Inverter generator high frequency permanent magnet alternator (5) and the Synchronous 50 cycle or 60 cycle alternator (6).

This would further increase the operational efficiency of the invention by eliminating bearing and windage losses from the Synchronous alternator (6) when not in use.

There can also be an optional Inverter generator storage power system (39), Inverter generator storage power system voltage sensor (40) Inverter generator storage power system charging system (41) that can be added to the invention.

There are many different procedures this Inverter generator storage power system (39) can be implemented. Here are a few examples but not limited to: The first use allows the DC to AC inverter (7) to assist the Synchronous alternator (6) for short term to enable greater surge capabilities to start large motor loads, similar in operation of a hybrid vehicle today, whereas the internal combustion engine is assisted by an electric motor for increased short term power output.

All the mechanical power from the Engine (2) is directed towards the Synchronous alternator (6) when in the high output mode and the Inverter generator high frequency alternator (5) is freewheeling, instead of supplying electrical power to the DC to AC inverter (7).

The CPU (14) can control the Engine (2) and Synchronous alternator (6) to produce proper voltage and frequency regulation while monitoring the required load by means of the Current sensing unit (15), Inverter generator current sensor (45), Synchronous alternator current sensor (46), Engine speed sensing unit (16), Electronic engine speed control (19) and the Engine ECU (3). There is a Synchronous alternator voltage regulation unit (20) and Synchronous alternator frequency regulation unit (21) in accordance with the load current by means of the Current sensing unit (15), Inverter generator current sensor (45) and Synchronous alternator current sensor (46).

There is a Synchronizing unit for the inverter generator and synchronous alternator (22) that enables the CPU (14) to monitor and control both the Inverter generator electrical output (43) and the Synchronous alternator electrical outputs (44) outputs and perfectly combines and matches them in both frequency and voltage to enable smooth transfer from one power setting to another to the required electrical load or have the capability of combining both the Inverter generator electrical outputs (43) and the Synchronous alternator electrical outputs (44) in a short term, for high surge capability by means of the Synchronizing unit for the inverter generator and synchronous alternator (22).

The Synchronizing unit for the inverter generator and synchronous alternator (22) will keep the both the Inverter generator electrical outputs (43) and the Synchronous alternator electrical outputs (44) synchronized and enable the two units to work together with the Inverter generator storage power system (39) supplying its stored electrical DC power to the Inverter generator (4), Therefore, assisting the Synchronous alternator (6) for short term high electrical demand situations by means of the Synchronizing unit for the inverter generator and synchronous alternator (22).

Another advantage of the Inverter generator storage power system (39) assisting the Engine (2) and the Synchronous alternator (6) is the capability for the CPU (14) to regulate the engine (2) rpm more precisely when encountering quick heavy surge loads. The CPU (14) will monitor the required load by means of the Current sensing unit (15), Inverter generator current sensor (45), Synchronous alternator current sensor (46), Engine speed sensing unit (14), Electronic engine speed control (17) and the Engine ECU (3).

The high surge will place a high mechanical load on the Engine (2) and the CPU (14) can activate the Inverter generator storage power system (39) supplying its stored electrical DC power to the Inverter generator (4) to assist the Synchronous alternator (6) for short term high electrical demand situations.

This can greatly improve the voltage and frequency regulation output from the Inverter generator electrical outputs (43) and Synchronous alternator electrical outputs (44) and avoid dips in frequency and voltage, due to the quick heavy surge placed on the Synchronous alternator (6) trying to slow the Engine (2) speed below the regulation required but not limited to: achieve 50 or 60 cycles by means of the CPU (14), Rectifier temperature sensor (10), Current sensing unit (15), Inverter generator current sensor (45), Synchronous alternator current sensor (46) Engine speed sensing unit (14), Electronic engine speed control (17), Engine ECU (3) and Synchronizing unit for the Inverter generator and synchronous alternator (22).

There is an Inverter generator storage power system voltage sensor (40) that is connected to the CPU (14) and the CPU (14) monitors the voltage in the Inverter generator storage power system (39) at all times.

When the heavy electrical load is reduced to the Synchronous alternator (6), Inverter generator (4) and the Inverter generator storage power system (39), the CPU (14) will monitor the electrical load by means of the Current sensing unit (15), Inverter generator current sensor (45) and Synchronous alternator current sensor (46) and if there was sufficient mechanical power left from the engine (2) after producing the required mechanical power needed to produce the electrical power from the Synchronous alternator (6).

The CPU (14) will then engage the Inverter generator storage power system charging system (41) at a calculated charge rate and load to the Engine (2), set forth by means of the CPU (14) and the Current sensing unit (15), Inverter generator current sensor (45) and Synchronous alternator current sensor (46) to calculate Engine (2) load and replenish the Inverter generator storage power system (39) for the next time the Inverter generator (4) is required to assist the Synchronous alternator (6) in a short term, high surge situation by means of the CPU (14), Synchronizing unit for the inverter generator and synchronous alternator (22) and Current sensing unit (15), Inverter generator current sensor (45) and Synchronous alternator current sensor (46).

Another procedure the Inverter generator storage power system (39) is the capability to assist the Inverter generator (4) in either the manual or automatic medium power output modes, for short term high surge electrical loads while the CPU (14) monitors the electrical load by means of the Current sensing unit (15), Inverter generator current sensor (45) and Synchronous alternator current sensor (46).

The capability to use the stored electrical potential in the Inverter generator storage power system (39) enables the CPU (14) to choose the Inverter generator (4) to stay in the automatic medium power output for a short time frame, without the need to engage the Synchronous alternator (6) by means of the CPU (14) and the CPU activated transfer switch high output breaker for synchronous alternator (26). This Inverter generator storage power system (39) assist procedure also enables the most stable and highest quality of electrical output from the Inverter generator (4).

Another procedure the Inverter generator storage power system (39) is capable of is the silent run mode. The CPU (14) can be manually or automatically programed by means of the CPU selector/s for modes (32) and/or Manual or automatic transfer switch to change between the inverter generator and the synchronous alternator (28) and this mode enables the Engine (2) to shut completely off and the Inverter generator storage power system (39) and the DC to AC inverter (7) will supply the electrical power to the load.

The silent run mode enables the Engine (2), Inverter generator high frequency permanent magnet alternator (5) and the Synchronous alternator (6) to be shut down during but not limited to: extreme light load situations ie: night time, small lights, charging cell phone, etc.

There is an Inverter generator storage power system voltage sensor (40) that is connected to the CPU (14) and the CPU (14) monitors the voltage in the Inverter generator storage power system (39). When the voltage drops to a predetermined level by means of the CPU selector/s for modes (32), the CPU (14) will signal the Engine (2) to start and operate at an rpm that produces the highest fuel efficiency per given mechanical load, by means of Engine ECU, Engine speed sensing unit (16), Electronic engine speed control (19).

When the Inverter generator storage power system (39) is fully charged the Inverter generator storage power system voltage sensor (40) will signal the CPU (14) and signal the Engine (2) to shutdown back to the silent mode. If the invention was left in the low power silent mode by means of the CPU selector/s for modes (32), it would be possible but not limited to; offering 48 hours or more operational times for one fuel tank in a portable generator.

There is an Inverter generator storage power system charging system (41) connected to the DC inputs on the Inverter generator storage power system (39), the CPU (14) monitors the Inverter generator storage power system (39) by means of the Inverter generator storage power system voltage sensor (40) and when the Inverter generator storage power system (39) voltage drops to a predetermined level by means of the CPU selector/s for modes (32) the CPU (14) starts the engine (2) and engages the Inverter generator storage power system charging system (41) by either a manual programmable charge rate by means of the CPU selector/s for modes (32) or an automatic charge rate by means of the CPU (14) and Current sensing unit (15), Inverter generator current sensor (45) and Synchronous alternator current sensor (46) to calculate engine load and properly calculated charge rate load, to replenish the Inverter generator storage power system (39).

This silent run mode with its fuel saving capabilities, enable the invention to be but not limited to: a generator for homes and businesses that offers the highest fuel efficiency possible. The silent run mode operation is similar to the function of a hybrid vehicle when it’s in traffic, the engine shuts down and the battery powers the vehicle in a light load situation. When the vehicle enters a high load situation ie: entering a highway, the vehicles engine is engaged to power the vehicle and the battery is replenished by means of the onboard battery charger.

The invention is more durable and robust than conventional inverter generator designs and enables better fuel economy than conventional synchronous alternator designs currently available today.

In the most basic configuration of the invention but not limited to: operates as follows: The user can manually select the Inverter generator (4) to operate as a known conventional mass produced inverter generator available today by means of the Manual or automatic transfer switch to change between the inverter generator and the synchronous alternator (28) and the Manual medium output breaker for inverter generator (23).

When the selected manual mode, the Inverter generator (4) electrical output would pass through the Manual medium output breaker for inverter generator (23) to supply electrical power to load with proper breaker systems for safety. When the selected automatic mode the Manual medium output breaker for inverter generator (23) is switched off and the Inverter generator (4) electrical output would pass through the CPU activated transfer switch medium output breaker for inverter generator (25) to supply electrical power to load with proper breaker systems for safety.

When in the automatic mode, the CPU (14) will monitor the electrical load by means of the Current sensing unit (15) and Inverter generator current sensor (45) and if the electrical load becomes but not limited to: a constant high load situation, the CPU (14) will increase engine speed to set proper frequency regulation by means of the engine ECU (3), Engine speed sensing unit (16), Electronic engine speed control (19) and then activate the Synchronous alternator (6) by means of the CPU activated transfer switch high output breaker for the inverter generator (26) and disengage the Inverter generator (4) by means of the CPU activated transfer switch medium output breaker for the inverter generator (25).Then the Synchronous alternator (6) will carry the high electrical demand until the electrical load is reduced for a but not limited to: a precalulated time frame.

The user can manually select the Synchronous alternator (6) to operate similar to a conventional mass produced synchronous alternator available today, by means of the Manual or automatic transfer switch to change between the inverter generator and the synchronous alternator (28) and the Manual high output breaker for synchronous alternator (24). When the selected manual mode, the Synchronous alternator (6) electrical output would pass through the Manual high output breaker for synchronous alternator (24) to supply electrical power to load with proper breaker systems for safety.

When the selected automatic mode, the Synchronous alternator (6) electrical output would pass through the CPU activated transfer switch high output breaker for synchronous alternator (26) to supply electrical power to load with proper breaker systems for safety.

When in the automatic mode, the Manual high output breaker for synchronous alternator (24) is switched off and the CPU (14) will monitor the electrical load by means of the Current sensing unit (15) and the Synchronous alternator current sensor (46) and if the electrical load becomes but not limited to: a constant low load situation, the CPU (14) will activate the Inverter generator (4) by means of the CPU activated transfer switch medium output breaker for inverter generator (25) and disengage the Synchronous alternator (6) by means of the CPU activated transfer switch high output breaker for synchronous alternator (26).

The Inverter generator (4) will carry the lower electrical demand until the electrical load is once again brought up to a high load situation for a but not limited to: a precalulated time frame. When the automatic mode is selected the CPU (14) can but not limited to: enable the Inverter generator (4) and the CPU activated transfer switch medium output breaker for inverter generator (25) to operate at lower power demands and then engage the Synchronous alternator (6) and the CPU activated transfer switch high output breaker for synchronous alternator (26) when higher power demand are required.

The invention operates as a one complete generator, incorporating 2 completely different types of known generators/alternators. Both generator/alternator designs offer advantages and disadvantages when compared to each other.

The invention enables to have one generator that operates at maximum efficiency and durability at all times. First, the inverter generator (4) offers increased fuel economy and longer run times between fill ups. They offers grid like power with great voltage and frequency stability with low distortion electrical output. Inverter generators cannot handle long duration, maximum electrical loads and are also not designed for heavy inductive loads and constant on and off high surge loads. Very clean electrical power, lighter duty.

Second, the Synchronous alternator (6) is more heavy duty, reliable and durable at powering long duration maximum electrical loads and heavy inductive loads, high surge loads, power heavy duty machinery, tools, home cooking appliances, well pumps and etc. but produce less precise voltage, frequency stability with higher distortion, electrical power output, with a higher fuel consumption rate compared, to the inverter generator. Not as clean electrical power but heavy duty.

By using a fully controllable dual generator system, with the Inverter generator (4) and Synchronous alternator (6) working as one flexible power generator, enables the invention to use both strong points on each design, without any shortcomings from either the inverter generator and synchronous alternator designs contain when used alone.

Also, the capability of the Inverter generator (4) assisting the Synchronous alternator (6) by means of the optional Inverter generator storage power system (39) and the Synchronizing unit for the inverter generator and synchronous alternator (22) enables the invention to produce very clean, very tight frequency regulation, heavy duty electrical power that conventional synchronous alternator design cannot offer.

The Engine (2) provides the mechanical energy which turns both the Inverter generator high frequency permanent magnet alternator (5) and the Synchronous alternator (6). Both the Inverter generator (4) and the Synchronous alternator (6) can be but not limited to: configured into a single or 3 phase and either a 50 cycle or 60 cycles design.

There is but not limited to: a Manual or automatic switch to change between the inverter generator to the synchronous alternator (28) to change from the Inverter generator (4) to the Synchronous alternator (6). This enables the user the option of using either power source. The Inverter generator (4) for but not limited to: medium electrical output requirements and the Synchronous alternator (6) for demanding, continuous, high electrical output requirements.

To operate the Inverter generator (4), the Engine ECU (3) works with the CPU (14), Current sensing unit (15), Inverter generator current sensor (45), Synchronous alternator current sensor (46) Engine speed sensing unit (16) and the Electronic engine speed control (19) to enable precise engine control and speed to produce sufficient mechanical power from the Engine (2) to operate the Inverter generator (4) and handle the electrical demand load in a variable speed manner.

To operate the Synchronous alternator (6) the Engine ECU (3) works with the CPU (14), Current sensing unit (15), Inverter generator current sensor (45), Synchronous alternator current sensor (46) Engine speed sensing unit (16), Electronic engine speed control (19) to enable precise engine control and speed to produce sufficient mechanical power from the Engine (2) to operate the Synchronous alternator (6) with the Synchronous alternator voltage regulation unit (20) and the Synchronous alternator frequency regulation unit (21) to ensure precise frequency and voltage regulation and handle the electrical demand load in a precise fixed speed manner.

The manual output mode is as follows, this is just one example of the many configurations this invention can be conformed to. The Inverter generator (4) operates completely independent from the Synchronous alternator (6). There is a CPU selector/s for modes (32) that enables to engage the manual mode in the CPU (14) and the user can manually determine either the Inverter generator (4) or the Synchronous alternator (6) to operate.

If the Inverter generator (4) manual medium mode only is chosen, by means of the CPU selector for modes (32) the Inverter generator (4) will operate in a similar manner as conventional inverter generators by varying the engine speed, to a higher engine speed when the electrical demand increases and a lower engine speed when the electrical demand decreases.

Here is just one example of the medium power operational engine rpm but not limited to: this is a lower rpm setting than a conventional inverter generator but the invention can operate at the higher engine speed similar to what conventional inverter generators normally operate as well, 3,000 - 4,500 rpm, which will increase fuel consumption and engine wear.

This is but not limited to: the more durable, fuel efficient, industrial engine speeds varying between 1,800 to 2,700 rpm, depending on the electrical load. The Engine (2) mechanical power output is perfectly matched to follow the required variable electrical power demand from the load to the Inverter generator (4) by means of the Engine ECU (3) works with the CPU (14), Current sensing unit (15), Inverter generator current sensor (45), Synchronous alternator current sensor (46), Engine speed sensing unit (16), Electronic engine speed control (19) to produce proper electrical power, stable frequency and voltage regulation to the load. There is a manual medium power output breaker for inverter generator (23) to protect the equipment from overload.

If the Synchronous alternator (6) manual high output mode only is chosen, by means of the CPU selector for modes (32), the manual high output mode can be locked in to the most powerful mode by means of the CPU selector for modes (32) the engine speed will be increased by the CPU (14), Engine ECU (3), Current sensing unit (15), Inverter generator current sensor (45), Synchronous alternator current sensor (46), Engine speed sensing unit (16), Electronic engine speed control (19).

The Synchronous alternator (6) will operate in a similar manner as a conventional synchronous alternator and operate continuously but not limited to: at a fixed 3,600 rpm engine speed if a 2 pole design synchronous alternator design was incorporated or a fixed 1,800 rpm engine speed if a 4 pole design synchronous alternator design was incorporated providing 60 cycles frequency and proper voltage to the load by the CPU (14), Engine ECU (3), Current sensing unit (15), Inverter generator current sensor (45), Synchronous alternator current sensor (46), Engine speed sensing unit (16), Electronic engine speed control (19), Synchronous alternator voltage regulation unit (20) and the Synchronous alternator frequency regulation unit (21). There is a Manual high power output breaker for synchronous alternator (24) to protect the equipment from overload.

There is an economy mode which enables the Inverter generator (4) to operate between but not limited to: low 1,200 or 1,800 rpm when the required electrical power is minimal. The output power is monitored by the Current sensing unit (15), Inverter generator current sensor (45) and Synchronous alternator current sensor (46) and when the electrical demand increases, the Engine ECU (3), CPU (14) can increase the engine speed up to but not limited to: 2,700 or more rpm by means of the Electronic engine speed control (19) and the Engine speed sensing unit (16) to increase the mechanical input power to drive the increased electrical load demand.

When the electrical load is decreased, the CPU (14) will monitor the load by means of the Current sensing unit (15), Inverter generator current sensor (45), Synchronous alternator current sensor (46) and lower the engine speed by means of the Electronic engine speed control (19), Engine speed sensing unit (16) and the Engine ECU (3), to conserve fuel.

The invention can be configured in the automatic medium power - high output mode by means of the CPU selector for modes (32). The automatic mode allows the Inverter generator (4) to operate as mentioned previously. When the CPU (14) monitors an electrical load that exceeds the Engine (2) and the Inverter generator (4) power capability by means of the current sensing unit (15), Inverter generator current sensor (45) and Synchronous alternator current sensor (46).

The CPU (14) will increase engine speed by means of the Engine speed sensing unit (16) and the Electronic engine speed control (19) and the Engine ECU (3) to but not limited to: 1,800 rpm in a 4 pole or 3,600 rpm in a 2 pole 60 cycle AC alternator design, incorporated in the Synchronous alternator (6).

The Inverter generator (4) can have a surge of but not limited to: 30 seconds. After that time interval, if the electrical demand stays in a high constant load, The CPU (14) will set the engine speed by means of the Engine speed sensing unit (16) and the Electronic engine speed control (19) and the Engine ECU (3) to but not limited to: to produce proper AC frequency regulation from the Synchronous alternator (6).

Then the CPU (14) can disengage the Inverter generator (4) by means of disengaging the CPU activated transfer switch medium output breaker (25) and engaging the Synchronous alternator (6) by means of the CPU activated transfer switch high output breaker (26) to protect the equipment when in the high output mode. This high output mode can provide continuous maximum electrical power long term.

When the Inverter generator (4) is at maximum surge mode for a time interval of but not limited to: 30 seconds and the Engine (2) rpm is increased to but not limited to: 1,800 or 3,600 rpm by means of the CPU (14) the Electronic engine speed control (19), Engine speed sensing unit (16) and the Engine ECU (3).

The CPU (14) instructs the Inverter generator (4) to operate at any rpm between but not limited to: these said engine rpm as well in a completely varying rpm manner to configure to the varying electrical load but the mentioned set engine speeds are to display simply the function of each mode.

When the electrical load is reduced to a but not limited to: precalulated level for a predetermined time, the CPU (14), Current sensing unit (15), Inverter generator current sensor (45) and the Synchronous alternator current sensor (46) will monitor the electrical load and begin to have the invention switch, from the operation of the high powered Synchronous alternator (6) mode back to the energy efficient Inverter generator (4) mode. The said precalulated level of electrical load and predetermined timeframe can be either manually or automatically programed by means of the CPU selector/s for modes (32).

Once the electrical load is reduced to a but not limited to: precalulated level for the said predetermined timeframe, the CPU (14) will disengage the Synchronous alternator (6) by means of disengaging the CPU activated transfer switch high output breaker (26) and engage the Inverter generator (4) by means of engaging the CPU activated transfer switch medium output breaker (25).

If there was a 60 cycle electrical load requirement, the operation modes but not limited to: economy mode can set the engine speed at 1,800 rpm, the medium output mode can set the engine speed at 2,700 rpm and the high output mode can set the engine speed at 3,600 rpm if a 2 pole synchronous alternator design was chosen. These examples can be configured into but not limited to: any 2 pole, 4 pole or 6 pole synchronous alternator design to produce either single or 3 phase output.

If there was a 50 cycle electrical load requirement, the operation modes but not limited to: economy mode can set the engine speed at 1,500 rpm, the medium output mode can set the engine speed at 2,250 rpm and the high output mode can set the engine speed at 3,000 rpm if a 2 pole synchronous alternator design was chosen. These examples can be configured into but not limited to: any 2 pole, 4 pole or 6 pole synchronous alternator design to produce either single or 3 phase output.

The CPU (14) can monitor the electrical demand by means of the Current sensing unit (15), Inverter generator current sensor and the (45), Synchronous alternator current sensor (46) while the invention is operating in the Inverter generator (4) mode and when the electrical load exceeds the precalulated level for a predetermined time interval of but not limited to: 30 seconds, the CPU (14) will again increase engine speed to set proper frequency regulation from the Synchronous alternator (6), by means of the engine ECU (3), Engine speed sensing unit (16), Electronic engine speed control (19) and then activate the Synchronous alternator (6) and disengage the Inverter generator (4) by means of the CPU activated transfer switch medium output breaker (25) and engage the Synchronous alternator (6) by means of the CPU activated transfer switch high output breaker (26) and the Synchronous alternator (6) will begin to operate, powering the heavy electrical load indefinitely or until the heavy load subsides.

To further increase operational efficiency, there can be an either an Electric clutch (37) or Mechanical/centrifugal clutch (38) added between the Inverter generator high frequency permanent magnet alternator (5) and the Synchronous alternator (6). This would enable greater fuel economy from said arraignments of the said solid coupling of the two: Inverter generator high frequency permanent magnet alternator (5) and the Synchronous alternator (6).

The CPU (14) can engage or disengage the Electric clutch (37) to enable the Synchronous alternator (6) to be completely disengaged and stop spinning, then Inverter generator (4) mode is engaged by means of the CPU activated transfer switch medium output breaker (25).

Then when the high output Synchronous alternator (6) mode is required, the CPU (14) can raise the engine speed by means of the Engine speed sensing unit (16) and the Electronic engine speed control (19) and the Engine ECU (3) and when the engine speed is at but not limited to: 1,800 rpm for a 4 pole and 3,600 rpm for a 2 pole synchronous alternator design.

The CPU (14) will energize the Electric clutch (37) and the Synchronous alternator (6) will now begin to spin at the same rpm as the Engine (2) and the Inverter generator high frequency permanent magnet alternator (5). Then the CPU (14) will disengage the Inverter generator (4) by means of the CPU activated transfer switch medium output breaker (25) and engage the Synchronous alternator (6) by means of the CPU activated transfer switch high output breaker (26) and the Synchronous alternator (6) will power the electrical load.

When said precalulated electrical load level for the said predetermined timeframe of the load is lowered determined by means of the CPU (14) and Current sensing unit (15), Inverter generator current sensor (45) and the Synchronous alternator current sensor (46) the CPU (14) can now engage the Inverter generator (4) mode by means of the CPU activated transfer switch medium output breaker (25) and disengage the Synchronous alternator (6) mode by means of the CPU activated transfer switch high output breaker (26) and the CPU (14) will lower the engine rpm to save fuel.

If a mechanical clutch (38) is added to the invention. The engagement of the mechanical clutch (38) can be but not limited to: a centrifugal clutch engagement system. The engine speed can raised or lowered to engage and disengage the mechanical/centrifugal clutch (38) by means of the CPU (14), Engine speed sensing unit (16), Electronic engine speed control (19) and the Engine ECU (3) to below the engagement speed of the mechanical clutch (38) to enable the Synchronous alternator (6) to be completely disengaged and stop spinning when the Inverter generator (4) mode is engaged.

Then when the high output Synchronous alternator (6) mode is required the CPU (14) can raise the engine speed by means of the Engine speed sensing unit (16) and the Electronic engine speed control (19) and the Engine ECU (3).

When the engine speed is at but not limited to: 1,800 rpm or 3,600 rpm, this will be slightly over but not limited to: the engagement speed of the mechanical/centrifugal clutch (38) set at but not limited to: 1,750 or 3,500 rpm and the Synchronous alternator (6) will now spin at the same rpm as the engine (2) and the Inverter generator high frequency permanent magnet alternator (5).

When the Engine (2) rpm reaches the engagement speed of the mechanical/centrifugal clutch (38), this engages the Synchronous alternator (6) and the CPU (14) can engage the CPU activated transfer switch high output breaker (26) and power the electrical load and the CPU can disengage the Inverter generator (4) by means of the CPU activated transfer switch high output breaker (25).

When the precalulated electrical load level for the predetermined timeframe of the load is lowered determined by means of the CPU (14) and Current sensing unit (15), Inverter generator current sensor and the (45) and the Synchronous alternator current sensor (46) the CPU (14) can now engage the Inverter generator (4) mode by means of the CPU activated transfer switch medium output breaker (25) and disengage the Synchronous alternator (6) mode by means of the CPU activated transfer switch high output breaker (26).

Then the CPU (14) lower the Engine (2) rpm by means of Engine speed sensing unit (16) and the Electronic engine speed control (19) and the Engine ECU (3) and the Engine (2) rpm will fall below the engagement speed of the mechanical clutch (38). The mechanical clutch (38) will disengage the Synchronous alternator (6) which will stop spinning and then the CPU (4) will engage the Inverter generator (4) by means of the CPU activated transfer switch medium output breaker (25) to power the electrical load.

These procedures of the Engine (2), Inverter generator (4), Synchronous alternator (6) operation with all said components enables the invention to provide a highly flexible and capable electrical power generating system in both electrical power production and fuel consumption.

This invention can be configured into many different designs to increase the capabilities of each generator design. The invention in a sense, a blend of an inverter generator and a synchronous alternator combined into one unit, either working independently in the manual mode or working in unison with the automatic mode by means of the Manual or automatic switch to change between the inverter generator and the synchronous alternator (28).

With the capability of the optional Inverter generator storage power system (39) to operate in the silent run mode. The CPU (14) can be manually or automatically programed by means of the CPU selector/s for modes and the Manual or automatic switch to change between the inverter generator and the synchronous alternator (28) which enables the Engine (2) to shut off completely and the Inverter generator storage power system (39) and the DC to AC inverter (7) supply the electrical needs to the load.

This mode enables the Engine (2), Inverter generator high frequency permanent magnet alternator (5) and the Synchronous alternator (6) to be shut down during light load situations ie: night time, small lights, charging cell phone, etc.

There is an Inverter generator storage power system voltage sensor (40) that is connected to the CPU (14) and the CPU (14) monitors the voltage in the Inverter generator storage power system (39). When the voltage drops to a predetermined level, the CPU (14) will signal the Engine (2) to start and operate at an engine speed that produces the highest fuel efficiency per given load.

There is a storage power system charging system (41) connected to DC to AC inverter (7) that recharges the inverter generator storage power system (39) once the Engine (2) starts. This mode with its fuel saving capabilities.

Another capability of the invention is but not limited to: the capability to use both the Inverter generator (4) and the Synchronous alternator (6) at the same time by means of the CPU (14) controlling both the Inverter generator (4) output by means of the CPU activated transfer switch medium output breaker for inverter generator (25) to the Inverter generator electrical outputs (43) and the Synchronous alternator (6) output by means of the CPU activated transfer switch high output breaker for inverter generator (26) to the Synchronous alternator electrical outputs (44).

This enables the extremely high quality AC power from the Inverter generator (4) to the Inverter generator electrical outputs (43) to be used for light loads requiring the best AC power available but not limited to: ie: computers, charging laptops, phones, charging cordless tools or operating sensitive equipment at a jobsite.

Then the but not limited to: heavy, inductive loads from a home or a jobsite running larger, heavy power equipment AC power from the Synchronous alternator (6) to the Synchronous alternator electrical outputs (44). The Inverter generator storage power system (39) can assist the Engine (2) by means of the CPU (14), Current sensing unit (15) Inverter generator current sensor (45) and the Synchronous alternator current sensor and the Synchronizing unit for the inverter generator and synchronous alternator (22) to provide short term clean AC power output, with proper frequency regulation and voltage from both the Inverter generator (4) and the Synchronous alternator (6).

The invention enables the capability for a generator to contain two completely different electrical outputs, by means of the Inverter generator electrical outputs (43) and the Synchronous alternator electrical outputs (44) operating both the Inverter generator (4) and Synchronous alternator (6) simultaneously by means of the CPU (14) by means of the Current sensing unit (15), Inverter generator current sensor (45) and Synchronous alternator current sensor (46) and varies the engine speed by means of Engine speed sensing unit (16) and Electronic engine speed control (19) in accordance with the load current by means of the Current sensing unit (15), Inverter generator current sensor (45) and Synchronous alternator current sensor (46), CPU selector/s for modes (32), CPU activated transfer switch medium output breaker for inverter generator (25) CPU activated transfer switch medium output breaker for synchronous alternator (26) and Synchronizing unit for the inverter generator and synchronous alternator (22) with or without the Inverter generator storage power system (39) to offer grid like power for sensitive electronics and heavy duty inductive loads from one generator.

The invention enables better fuel economy than conventional synchronous alternator designs. Also providing a more resilient and durable generator than conventional inverter generator designs currently available today, with even lower fuel consumption rates, due to the shutdown capability at night time or during lower power consumption hours.

The invention enables the capability for a generator if left in the low power silent mode in an emergency, to provide the user a generator that can produce small amounts of electrical power 24 hours a day and require the least amount of fuel for extended power outages. Then in the same generator, have the capability to reliably inductive power heavy loads with ease.

The invention enables the capability for a generator if left in the medium power to produce the highest fuel efficiency with the lowest noise, matching todays inverter generators.

The invention enables the capability for a generator if left in the high power to produce the highest continuous power level similar to today’s conventional synchronous alternator designs but with much greater voltage and frequency regulation and almost matching conventional inverter generator in AC quality, due to the capability to incorporate the Inverter generator (4) to assist the Engine (2) powering the Synchronous alternator (6) by means of the Inverter generator storage power system (39) and Synchronizing unit for the inverter generator and synchronous alternator (22).

The invention enables the capability for a generator if left in the automatic mode to produce the highest fuel efficiency with the lowest noise and the highest continuous power level with greater voltage and frequency regulation, in one complete generator system.

I claim:

1. The invention claimed is, an electricity producing device, comprising: an Internal combustion engine (2), an Inverter generator (4) and a Synchronous alternator (6), all said elements, Internal combustion engine (2), Inverter generator (4) and Synchronous alternator (6), are combined into one electrical generator unit.

2. The invention claimed is, an electricity producing device, comprising: a known Internal combustion engine (2) that produces rotational, mechanical input power and is coupled to, in any order, a known Inverter generator (4) and a known Synchronous alternator (6), enabling all said elements, known Internal combustion engine (2), known Inverter generator (4) and known Synchronous alternator (6) to rotate in sync with one another and are combined into one electrical generator unit.

3. The invention claimed is, an electricity producing device, comprising: an Internal combustion engine (2) supplies rotational input power and is coupled to both, in any order, an Inverter generator (4) and a Synchronous alternator (6), enabling all said elements, to rotate in sync with one another and are combined into one electrical generator unit.

4. The invention claimed is, an electricity producing device, as recited in claim 3, further comprising: that there is an Inverter generator high frequency permanent magnet alternator (5), producing alternating current, which is then converted to direct current by means of a Rectifying system (9), a DC to AC inverter (7) is attached to the said direct current and produces alternating current, an Inverter generator pulse width modulation control (18) is connected to the said alternating current to produce proper output voltage and frequency regulation alternating current and is connected to the Inverter generator alternating current output leads (43), said Synchronous alternator (6), producing alternating current, a Synchronous alternator voltage regulation unit (20), produce proper alternating current voltage to the Synchronous alternator electrical outputs (44).

5. The invention claimed is, an electricity producing device, as recited in claim 3, further comprising: that there is a frame (1) an Engine ECU (3), said Inverter generator (4), further consist of DC to AC inverter temperature sensor (8), Capacitors (11), CPU (14), Current sensing unit (15), Engine speed sensing unit (16), Inverter generator current line filter (17), Electronic engine speed control (19), Synchronous alternator frequency regulation unit (21), Synchronous unit for the inverter generator and synchronous alternator (22), Inverter generator current sensor (45), Synchronous alternator current sensor (46).

6. The invention claimed is, an electricity producing device, as recited in claim 3, further comprising: that there is Manual medium output breaker inverter generator (23), a Manual high output breaker for synchronous alternator (24), CPU activated transfer switch medium output breaker inverter generator (25), CPU activated transfer switch high output breaker synchronous alternator (26), generator control panel (27), Manual or automatic transfer switch to change from inverter generator to the synchronous alternator (28), Electrical output for hard wiring (29), Electrical output for plug (30), On-off starting switch selector (31), CPU selector for modes (32), fuel tank (33), Starting battery/capacitor power system (36).

7. The invention claimed is, an electricity producing device, as recited in claim 3, further comprising: that there is an Electric clutch (37), between the Inverter generator (4) and Synchronous alternator (6).

8. The invention claimed is, an electricity producing device, as recited in claim 3, further comprising: that there is a Manual/centrifugal clutch (38) between the Inverter generator (4) and Synchronous alternator (6).

9. The invention claimed is, an electricity producing device, as recited in claim 3, further comprising: that there is an Inverter generator power system (39), Inverter generator power system voltage sensor (40), Inverter generator power system charging system (41), Transformer (42).
